(19) United States
(12) Patent Application Publication
(10) Pub. No.: US 2013/0327699 A1
(43) Pub. Date: Dec. 12, 2013

(54) FUEL FILTER

(71) Applicants: Matthias Gaenswein, Esslingen (DE); Michael Braunheim, Goeppingen (DE); Claude Frédéric Gebler, Stuttgart (DE); Hartmut Harr, Waldenbuch (DE); Marc Igerc, Bleiburg (DE); Peter Koppi, Sankt Margarethen (AT); Hans Waibel, Remseck/Aldingen (DE)

(72) Inventors: Matthias Gaenswein, Esslingen (DE); Michael Braunheim, Goeppingen (DE); Claude Frédéric Gebler, Stuttgart (DE); Hartmut Harr, Waldenbuch (DE); Marc Igerc, Bleiburg (DE); Peter Koppi, Sankt Margarethen (AT); Hans Waibel, Remseck/Aldingen (DE)

(73) Assignee: Mahle International GmbH, Stuttgart (DE)

(21) Appl. No.: 13/992,570

(22) PCT Filed: Dec. 9, 2011
(86) PCT No.: PCT/EP11/72320

§ 371 Date: Aug. 26, 2013

(30) Foreign Application Priority Data
Dec. 10, 2010 (DE) 102010062813.1

(51) Int. Cl. B01D 35/00

(52) U.S. Cl. CPC B01D 35/005
USPC 210/335; 210/323.1

(57) ABSTRACT

A fuel filter may include a housing having a first annular filter element and a second annular filter element. The filter elements may be arranged coaxially and offset to each other in the axial direction and may be connected in series and therefore configured to allow flow to pass through each in succession. The annular filter elements may be selectively replaceable. Adapter elements may be connected to each other and to at least one of the annular filter elements by a respective plug-in connection. One of the adapter elements may have a continuation configured to close a no-load opening in the housing when the filter element is inserted.

### CROSS-REFERENCE TO RELATED APPLICATIONS

This application claims priority to German Patent Application 10 2010 062 813.1 filed on Dec. 10, 2010, and International Patent Application PCT/EP2011/072320 filed on Dec. 9, 2011, both of which are hereby incorporated by reference in their entirety.

### TECHNICAL FIELD

The present invention relates to a fuel filter, in particular a fuel filter having an annular filter element through which flow passes radially according to the preamble of claim 1.

### BACKGROUND

DE 10 2006 060 128 A1 discloses a generic fuel filter which is used as a fuel filter in an internal combustion engine of a motor vehicle. In particular when such fuel filters are used as fuel filter, it is important for a long service life of the internal combustion engine that as much of the water still contained in the fuel is filtered out as possible in order to prevent corrosion processes resulting therefrom inside the internal combustion engine.

### SUMMARY

The present invention is concerned with the problem of specifying an improved or at least an alternative embodiment for a fuel filter of the generic type, which in particular has a good filtering effect.

This problem is solved according to the invention by the subject matter of independent claim 1. Advantageous embodiments form the subject matter of the dependent claims.

The present invention is based on the general concept of additionally providing at least one, preferably two further annular filter elements in a fuel filter which is known per se and has a housing and a first annular filter element arranged therein and thereby achieving a particularly good filtering and deposition effect. All of the at least two, preferably three annular filter elements are arranged coaxially to each other, at least two of the preferably three annular filter elements also being arranged offset to each other in the axial direction. All the annular filter elements are furthermore connected in series, and therefore flow passes through them in succession. The fuel must thus flow through at least two, preferably three annular filter elements from the untreated side to the clean side, which is the reason for the good filtering effect of the fuel filter according to the invention. The coaxial arrangement offset in the axial direction of the individual annular filter elements means that they can also easily be replaced separately, as a result of which the fuel filter can be constructed in a maintenance-friendly manner overall. The total of at least two, preferably three annular filter element can thus realise two, three or more filter stages, it being possible for example for dirt particles to be filtered out and an at least slight coalescence of the water entrained in the fuel to be achieved in the first filter stage, that is, at the first annular filter element. During this comparatively slight coalescence, water droplets are enlarged somewhat, which are then further coalesced, that is, further enlarged, at the second annular filter element, that is, at the second filter stage, which is for example formed purely as a coalescence stage. Cellulose, including native cellulose, which can be used in particular in the forms of a woven, knitted, looped or fleece fabric, can be used for example as the material in this case. In the subsequent third filter stage, that is, at the third annular filter element, a fine-meshed net of hydrophobic material can then be provided, so the third annular filter element functions as a final separator, which stops the water droplets which were enlarged in the first and second filter stages from passing through and deposits them. The fuel which has already been pre-cleaned by the first and second filter stages is thus filtered again and at the same time dewatered at the third filter stage and by the third annular filter element. With the at least two-stage, preferably three-stage fuel filter according to the invention, a particularly good filtering effect can be achieved, in particular with respect to dirt and solid particles, as well as a much improved dewatering of the filtered fuel. The filter fuel contains less residual water overall, as a result of which a risk of corrosion can be reduced.

Further important features and advantages of the invention can be found in the subclaims, the drawings and the associated description of the figures using the drawings.

It is self-evident that the above-mentioned features and those still to be explained below can be used not only in the combination given in each case but also in other combinations or alone without departing from the scope of the present invention.

Preferred exemplary embodiments of the invention are shown in the drawings and are explained in more detail in the description below, the same reference symbols referring to the same or similar or functionally equivalent components.

### BRIEF DESCRIPTION OF THE DRAWINGS

In the figures,

FIG. 1 schematically shows a sectional diagram through a first embodiment of a fuel filter according to the invention,

FIG. 2 schematically shows a section diagram as in FIG. 1 but in a second embodiment in which the first and second annular filter elements are arranged coaxially and not axially at a distance from each other,

FIG. 3a schematically shows a sectional diagram through a possible embodiment of a second ring filter element,

FIG. 3b schematically shows a view of the second annular filter element according to the embodiment of FIG. 2.

### DETAILED DESCRIPTION

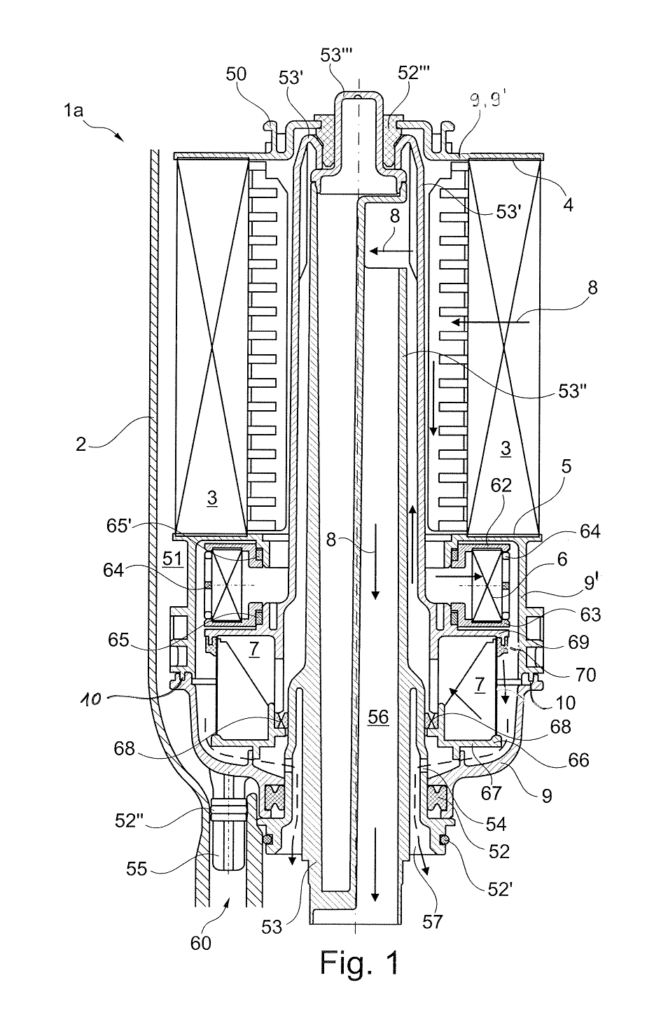

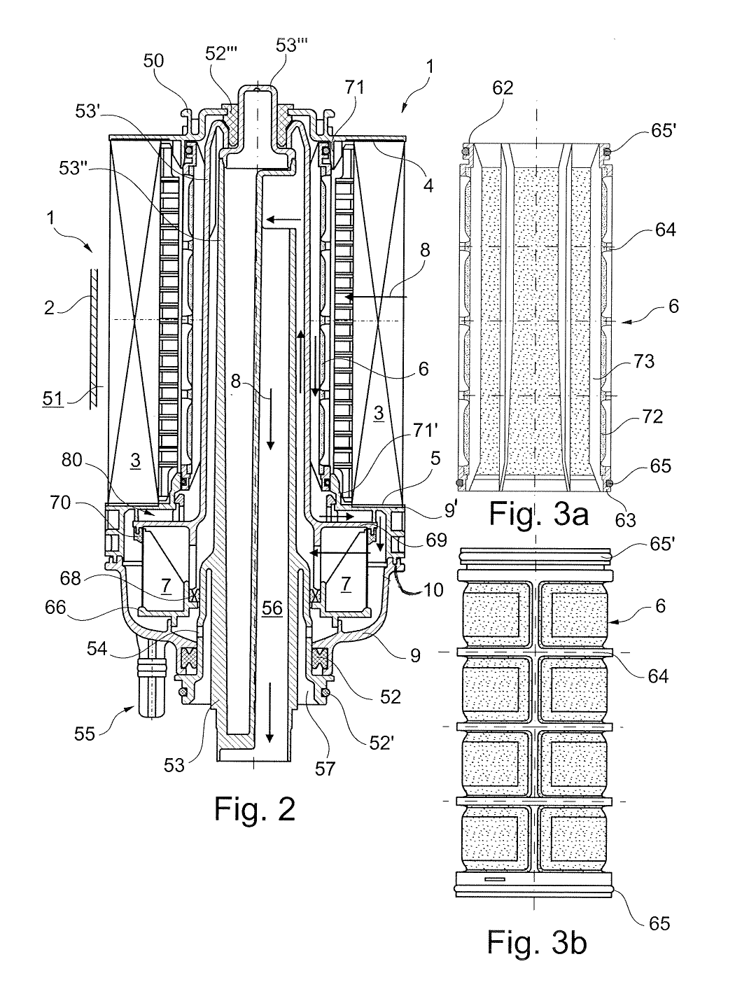

According to FIGS. 1 and 2, a fuel filter 1a according to the invention, which can be configured under some circumstances as a customary fluid filter, in particular as an oil filter, has a housing 2, which is merely suggested. In order to be able to change the annular filter elements 3, 6, 7, the housing 2 must be designed to be opened. To this end, it has what is known as a housing pot and a housing lid connected detachably thereto. The first annular filter element 3 is connected to the housing 2 by latching means 50. When the housing 2 is opened, the first annular filter element 3 can thereby be removed by means of the housing part latched thereto from the other housing part. In the configuration according to the invention, all the annular filter elements 3, 6, 7 are connected to each other, so the filter device 1 can be taken completely out of the housing 2 of the fuel filter 1a when the housing 2 is opened. Of course, the structure can be selected to be such that only parts of the filter device 1 can be taken out of the housing 2 and the rest remain in the housing 2 or can be taken out separately. The filter device according to the invention consists of at least two annular filter elements 3, 6, 7, adapter elements 9, 9′ and a functional carrier 53. The housing 2 is absolutely necessary for the function, but is not part of the filter device 1 in this case.

A first annular filter element 3, which has an upper and a lower end disc 4 and 5, is arranged in the housing 2. In this case top and bottom refer to FIG. 1 and not necessarily to the installation position in a motor vehicle. The filter device 1 is preferably installed in a standing or suspended manner in the fuel filter 1 a, top in FIG. 1 also meaning top with regard to the installation position. The upper end disc 4 has the latching means 50 with which the first annular filter element 3 is fastened in a rotatable manner to one housing part. The lower end disc 5 of the first annular filter element 3 is preferably flat. The adapter element 9′ is fixed thereto. It can be produced directly together with the lower end disc 5 or else connected by a suitable method such as welding to the lower end disc 5 after production of the first filter element 3.

A further adapter element 9 can be fastened to this adapter element 9′, which is connected to the lower end disc 5 of the first filter element 3. If it is desired that the further annular filter elements 6, 7 be made replaceable, a connection 10 between adapter element 9 and 9′ can be detachable, e.g. by screw fastening, clipping etc. It is important that this connection 10 of the two adapter elements 9 and 9′ is sealed off from the untreated space 51. These two adapter elements 9 and 9′ form a type of pot, which is fastened in a sealing manner by means of a seal 52 from a dome of the housing 2 or a dome of a functional carrier 53 in which the housing 2 can remain. The adapter element 9 further has an integrally formed continuation 55, which seals off a no-load duct 60 of the filter device 1 when the filter device 1 is inserted in the housing 2.

The functional carrier 53 has an opening 54 through which the water deposited from the fuel can drain from the clean side of the first annular filter element 3 into a water collection space (not shown in detail), which can be situated underneath the filter device 1. The functional carrier 53 consists of a plurality of parts 53′, 53″ and 53″. The inner part 53″ contains a drainage duct 56 of the clean side; the adapter element 9 is attached in a leakproof manner to this. The outer part 53′ together with a projection 69 forms the holder for the third annular filter element 7.

In both exemplary embodiments, the adapter element 9 is sealed off by means of the seal 52 from the dome of the functional carrier 53 and thus fastened detachably to the latter. The functional carrier 53 contains an outflow duct 56 for fuel on the clean side of the filter device 1 and in its lower part an opening 54 and an associated water drainage duct 57. The functional carrier 53 is sealed off from the housing 2 by means of a further seal 52′.

According to the invention, then, a second annular filter element 6 and a third annular filter element 7 are provided. All of these annular filter elements 3, 6, 7 are arranged coaxially to each other, at least two of the total of three annular filter elements 3, 6, 7 also being arranged offset to each other in the axial direction. If the embodiment of the fuel filter 1a according to the invention in FIG. 1 is viewed, all the annular filter elements 3, 6, 7 are arranged offset to each other in the axial direction and in particular at a distance from each other, whereas in a second embodiment which is shown in FIG. 2, although the first annular filter element 3 and the second annular filter element 6 are arranged coaxially to each other, they do not have an axial offset to each other or an axial distance from each other. However, the embodiments all have in common that all the annular filter elements 3, 6, 7 are connected in series with each other and therefore flow passes through them in succession. Also common to all the embodiments is a meander-shaped flow through the annular filter elements 3, 6 and 7, which is particularly pronounced in the filter device 1 (fuel filter 1a) according to FIG. 1.

The lower end disc 5 of the first annular filter element 3 has a projection 61 on its inner edge, against which projection the second annular filter element 6 bears in a sealing manner.

In the first embodiment in FIG. 1, the second annular filter element 6 has an upper end disc 62 and a lower end disc 63. The second annular filter element 6 shown here also has a folded star consisting of material suitable for coalescence; an equivalent shape to a folded star can alternatively be selected, e.g. a knitted fabric consisting of cellulose or fibreglass situated between two protective layers. The second annular filter element 6 needs an outer frame 64 for support in the flow direction. This outer frame 64 is connected fixedly to the respective end discs 62 and 63 of the second annular filter element 6. The two end discs 62 and 63 have suitable sealing recesses to accommodate the seal 65 and 65′, which seal the second annular filter element 6 from the lower end disc 5 of the first annular filter element 3 and from the dome of the functional carrier 53. To this end, the dome of the functional carrier 53 has suitable counter contours for supporting the seal. The respective design of the sealing contours both on the functional carrier 53 and on the end discs 62, 63 depends on the shape of the second annular filter element 6.

In the first embodiment, the third annular filter element 7 has a supporting frame 66, in which the final separator in the form of a hydrophobic woven fabric is fastened. In FIG. 1, the third annular filter element 7 has the shape of a ring. According to FIG. 1, it is closed at the bottom with a base 67 against which a seal 68 bears, which seals off from the functional carrier 53. This supporting frame 66 can be fastened to the projection 69 of the functional carrier 53. If the third annular filter element 7 has a different shape, the functional carrier 53 must be adapted. If it is desired that the third annular filter element 7 be replaceable, a connection 70 between the projection 69 and the supporting frame 66 must be detachable, e.g. in the form of a screw fastening, clip fastening or latch fastening. In a different case, the third annular filter element can be connected fixedly to the functional carrier 53, e.g. by welding to the same.

Assembly takes place as follows for the first exemplary embodiment: First, the lower adapter element 9 must be placed onto the functional carrier part 53″. After the outer functional carrier part 53′ together with the third annular filter element 7 has been attached to the part 53″ on the functional carrier part 53″, the second annular filter element 6 is placed over this onto the functional carrier 53. Finally, the first annular filter element 3 is fastened with its end disc 5 to the functional carrier 53 and to the adapter element 9. The upper end disc 4 of the first annular filter element 3 bears in a leakproof manner against the upper end of the functional carrier 53 by means of a further seal 52″. When the filter device 1 is changed, it is removed completely from the housing 2. The the individual parts can be separated from each other and only the ones that need are replaced.

FIG. 2 shows an alternative embodiment. In this case the first annular filter element 3 is almost the same as the first exemplary embodiment. Changes needed to be made at the end discs 4 and 5 in order to be able to fasten the second annular filter element 6 in a leakproof manner thereto. Both end discs 4 and 5 have inwardly facing edges 71 and 71′. They act as a bearing face for the seals 65 and 65′ of the second annular filter element 6. This is shaped differently in the second exemplary embodiment. It has very reduced end discs 62 and 63 with grooves for the seals 65 and 65′. The outer supporting frame 64 is fastened to the end discs 62 and 63. The in this case thin filter medium 72, which should in particular have coalescence properties, bears against the said frame, and there are stabilising ribs 73 on the inside, that is, upstream of the filter medium 72, to stay the thin filter medium 72.

In this exemplary embodiment too, the third annular filter element 7 is formed from a supporting frame 66 and a hydrophobic screen. The supporting frame 66 is fastened detachably to the connection 70 with the functional carrier 53 by suitable connecting means. The third annular filter element 7 is sealed off from the functional carrier 53 by means of a seal 68, so no mixing of the clean side 56 with the fuel which still contains water takes place upstream of the third annular filter element 7. If required, the third annular filter element 7 can be connected in a non-detachable manner to the functional carrier 53, e.f. by welding. Flow-directing elements can be provided in the duct 80 which is situated between the lower end disc 5 of the first annular ring filter element 3 and the projection 69 of the functional carrier 53 in order to increase the water deposition rate. These flow-directing elements can be formed in particular in such a manner that they produce a tangential flow, that is, which flows parallel to the surface of the filter element 7.

Assembly takes place as follows for the second exemplary embodiment: First, the lower adapter element 9 must be placed onto the functional carrier part 53″. After the outer functional carrier part 53′ together with the third annular filter element 7 has been attached to the part 53″, the first annular filter element 3 with the second annular filter element 6 integrated therein is placed over this onto the functional carrier 53. Finally, the first annular filter element 3 is fastened with its end disc 5 to the functional carrier 53 and to the adapter element 9. The upper end disc 4 of the first annular filter element 3 bears in a leakproof manner against the upper end of the functional carrier part 53′″ by means of a further seal 52′″. When the filter device 1 is changed, it is removed completely from the housing 2. The the individual parts can be separated from each other and only the ones that need are replaced.

If the fuel filter 1a of FIG. 1 is viewed, it can be seen that flow passes radially through all the annular filter elements 3, 6 and 7, through the first annular filter element 3 from the outside inwards, the second annular filter element 6 from the inside outwards, and the third annular filter element 7 again from the outside inwards. In contrast to this, in the fuel filter 1a of FIG. 2, flow passes also through the second annular filter element 6 from the outside inwards.

Generally, the first annular filter element 3 is formed as a dirt filter and is therefore used to filter out dirt particles. The first annular filter element 3 can also have an at least slight coalescer function and thereby enlarge water droplets present in the fuel. The second annular filter element 6 is preferably formed purely as a coalescer and enlarges the emulsified water droplets further. A native cellulose, which is in turn formed as a fleece or a looped, knitted or woven fabric, can for example be used as the material for the second annular filter element 6. Of course, other or further coalescence materials can be used in the woven or fleece or looped form mentioned. Finally, the third annular filter element 7 is formed as a hydrophobic final separator and at the same time as a dirt filter, a hydrophobic and fine-meshed net being selected as the material for the third annular filter element 7. This hydrophobic net prevents the water droplets which were enlarged by the first and second annular filter elements 3 and 6 from passing through, so they can be collected in a water collection space 8 situated below the third annular filter element 7. The fuel filter 1 a according to the invention is thus able to effect particularly good filtration and at the same time withdraw as much of the entrained water as possible, as a result of which in particular a tendency to corrode can be reliably reduced. The flow of the fuel to be filtered inside the filter device 1 is shown with flow arrows 8.

If the fuel filters 1a of FIGS. 1 and 2 are viewed, it can be seen that the individual annular filter elements 3, 6, 7 are formed separately from each other and as a result can be replaced separately. To fasten or hold the individual annular filter elements 3, 6 and 7 in the fuel filter 1a, adapter elements 9, 9′ can be provided, which can be connected to each other and to at least one of the ring filter elements 3, 6, 7 by means of a respective plug-in connection 10.

If FIGS. 3a and 3b are viewed, it can be seen that the second annular filter element 6 in the fuel filter 1a shown according to FIG. 2 has only a looped or knitted fabric or a fleece as the filter medium and is thereby formed purely as a coalescer. The term “annular filter element” in this case should be understood only in a transferred sense. However, in the case of the second annular filter element 6 according to the embodiment of FIG. 1, the term “annular filter element” is correct.

With the fuel filter 1a according to the invention, which can generally also be applied to other fluid filters in the transferred sense, particularly effective filtering of the fluid to be filtered, in particular of the fuel to be filtered, can be achieved, it being possible not only to filter the said fluid but also dewater it. It is thus possible with the fluid filter according to the invention or the fuel filter 1a according to the invention both to filter out solids and to filter out liquids, for example water. The possibility of replacing the annular filter elements 3, 6 and 7 individually and therefore separately from each other means that the ease of maintenance of the fuel filter 1a according to the invention can be much improved.

1. A fuel filter, comprising: a two-part housing including a first annular filter element
and a second annular filter element,
wherein the annular filter elements are arranged coaxially and offset to each other in the axial direction,
further wherein the annular filter elements are connected in series and therefore flow passes through each in succession
wherein the annular filter elements are selectively replaceable,
adapter elements connected to each other and to at least one of the annular filter elements by a respective plug-in connection, and
wherein one of the adapter elements has a continuation configured to close a no-load opening in the housing when the filter element is inserted.

2. The fuel filter according to claim 1, wherein flow passes radially through all the annular filter elements, through at least one of
the first annular filter element from the outside inwards, and
the second annular filter element from the inside outwards or from the outside inwards.

3. The fuel filter according to claim 1, wherein the first annular filter element is formed as a particle filter.

4. The fuel filter according to claim 1, wherein the second annular filter element (6) is formed as a coalescer.

5. The fuel filter according to claim 1, further comprising a third annular filter element is formed as a hydrophobic final separator and particle filter.

6. The fuel filter according to claim 1, wherein the second annular filter element has at least one of a fleece, a looped, a knitted and a woven fabric with coalescence properties.

7. The fuel filter according to claim 5, wherein the third annular filter element has a hydrophobic, fine-meshed net configured as a final water separator.

8. The fuel filter according to one of claim 1, wherein the annular filter elements are arranged at an axial distance from each other.

9. A fuel filter, comprising: a housing including a first annular filter element,
a second annular filter element and a third annular filter element,
wherein the annular filter elements are arranged coaxially and offset to each other in the axial direction and further wherein the annular filter elements are connected in series and therefore flow passes through each in succession and wherein the annular filter elements are selectively replaceable,
adapter elements connected to each other and to at least one of the annular filter elements by a respective plug-in connection, wherein one of the adapter elements has a continuation configured to close a no-load opening in the housing when the filter element is inserted.

10. The fuel filter according to claim 9, wherein flow passes radially through at least one of the first annular filter element from the outside inwards, the second annular filter element from the inside outwards or from the outside inwards, and the third annular filter element again from the outside inwards.

11. The fuel filter according to claim 9, wherein the first annular filter element is formed as a particle filter.

12. The fuel filter according to claim 9, wherein the second annular filter element is formed as a coalescer.

13. The fuel filter according to claim 9, wherein the third annular filter element formed as a hydrophobic final separator and particle filter.

14. The fuel filter according to claim 9, wherein the second annular filter element has at least one of a fleece and looped, knitted and woven fabric with coalescence properties.

15. The fuel filter according to claim 9, wherein the third annular filter element has a hydrophobic, fine-meshed net configured as a final water separator.

16. The fuel filter according to claim 9, wherein the annular filter elements are arranged at an axial distance from each other.

17. The fuel filter according to claim 10, wherein the first annular filter element is formed as a particle filter.

18. The fuel filter according to claim 17, wherein the second annular filter element is formed as a coalescer.

19. The fuel filter according to claim 18, wherein the third annular filter element formed as a hydrophobic final separator and particle filter.

20. The fuel filter according to claim 10, wherein the third annular filter element has a hydrophobic, fine-meshed net configured as a final water separator.
